(19) United States
(12) Patent Application Publication
(10) Pub. No.: US 2011/0049425 A1
(43) Pub. Date: Mar. 3, 2011

(54) BIODEGRADABLE DESICCANT GRAIN AND METHOD FOR MAKING THE SAME

(75) Inventors: Chih-Hsien HUANG, Taipei City (TW); Wen-Chih WU, TAICHUNG CITY (TW)

(73) Assignee: WEI MON INDUSTRY CO., LTD., HSINCHU COUNTY (TW)

(21) Appl. No.: 12/874,224

(22) Filed: Sep. 2, 2010

(30) Foreign Application Priority Data
Sep. 3, 2009 (TW) 98129734

(51) Int. Cl. C09K 3/00

(52) U.S. Cl. 252/194

(57) ABSTRACT

Biodegradable desiccant grains include 80-85 weight parts of a polylactide matrix and 20-30 weight parts of water absorbent particles dispersed in the matrix. The water absorbent particles include polysaccharide, biodegradable polymers, natural calcium carbonate, and activated charcoal. A method for making the biodegradable desiccant grains is also disclosed.

### RELATED APPLICATIONS

This application claims priority to Taiwan Application Serial Number 98129734, filed Sep. 3, 2009, which is herein incorporated by reference.

### BACKGROUND

1. Field of Invention

The present invention relates to a desiccant. More particularly, the present invention relates to a biodegradable desiccant.

2. Description of Related Art

Many sophisticated machine, drugs, chemicals, foods, and leatherware need to be operated or stored in a dry environment. Otherwise, moisture encourages the growth of mold and spoilage in many items, such as leatherware and foods. Alternatively, moisture may also damage other items like electronics and may speed the decomposition and hydrolysis of chemicals.

Therefore, desiccant is important to these products, since the moisture in the environment heavily affects human life. The desiccant is most commonly used to remove excessive moisture that would normally degrade or even destroy products sensitive to moisture. Silica gel and calcium oxide are commonly used as desiccant.

However, the silica gel and the calcium oxide can easily harm user's body and cause environmental pollution after they are discarded. For example, if the calcium oxide, commonly known as quicklime, is eaten, the user's mouth or esophagus is burned. Alternatively, if the calcium oxide is splashed into the user's eyes, the conjunctiva and cornea are damaged. As for the silica gel, it is semi-transparent grains and is usually doped with a moisture indicator, such as cobalt (II) chloride. However, cobalt (II) chloride is toxic and may be carcinogenic. Furthermore, cobalt (II) chloride is deep blue when dry (anhydrous form) and pink when moist (hydrated form), so the silica gel is easily eaten by children.

### SUMMARY

Biodegradable desiccant grains are provided. The biodegradable desiccant grains include 80-85 weight parts of a polylactide matrix and 20-30 weight parts of water absorbent particles dispersed in the polylactide matrix. The water absorbent particles include a polysaccharide, biodegradable polymers, natural calcium carbonate, and activated charcoal.

A method for making biodegradable desiccant grains is provided. The method includes the following steps: A first mixture is blended with a second mixture to form a uniform mixture. In the uniform mixture, the materials of the second mixture with water absorbing and porous properties are carried by the first mixture.

In accordance with an embodiment of the present disclosure, the first mixture includes polylactide matrix, lignin powder, activated charcoal, starch-acrylic acid graft copolymer, and natural calcium carbonate.

In accordance with an embodiment of the present disclosure, the second mixture includes a poly(acrylic acid) salt, polycaprolactone and an uronic acid-containing polysaccharide extracted from Cyanobacteria.

### BRIEF DESCRIPTION OF THE DRAWINGS

FIG. 1 is F an operational and schematic view of a device for preparing biodegradable desiccant grains in accordance with an embodiment of the present disclosure.

### DETAILED DESCRIPTION

Biodegradable desiccant grains include a polylactide matrix and water absorbent particles dispersed in the polylactide matrix. According to the embodiment, the content of the polylactide matrix is 80-85 weight parts and the content of the water absorbent particles is 20-30 weight parts.

Polylactide is a kind of biodegradable material formed by conversion, fermentation and polymerization of the starch of the plant and hence is biodegradable. The polylactide has good rigidity. Therefore, the polylactide can be the carrier matrix of the biodegradable desiccant grains.

The water absorbent particles include a polysaccharide, biodegradable polymers, natural calcium carbonate, and activated charcoal. In one embodiment of the present disclosure, the water absorbent particles dispersed in the matrix include 2-4 weight parts of the polysaccharide, 9-12 weight parts of biodegradable polymers, 5-6 weight parts of natural calcium carbonate; and 1-2 weight parts of activated charcoal.

Water absorbent particles absorb the moisture by the capillary phenomenon between the hydrophilic group of some of the biodegradable polymers and the uronic acid-containing polysaccharide extracted from Cyanobacteria. The hydrophilic group can be shared with the uronic acid-containing polysaccharide, the poly(acrylic acid) salt, and polycaprolactone, for example.

Since the polylactide is rigid, the biodegradable desiccant grains are crisp and fragile; the biodegradable polymers are also used as the modifiers to play important roles of decrease the rigidity of the biodegradable desiccant grains.

In accordance with one or more embodiments of the present disclosure, the polysaccharide is a polysaccharide containing uronic acid extracted from Cyanobacteria. In one embodiment of the present disclosure, 2-4 weight parts of uronic acid-containing polysaccharide extracted from Cyanobacteria is is provided.

In accordance with one or more embodiments of the present disclosure, the biodegradable polymers include lignin powder with fiber length of 40 μm and bulk density of 220 g/l, a polycaprolactone, a starch-acrylic acid graft copolymer, and a poly(acrylic acid) salt. The poly(acrylic acid) salt is poly(acrylic acid) sodium salt, poly(acrylic acid) potassium salt poly(acrylic acid) ammonium salt, or the combinations thereof, for example. In one embodiment of the present disclosure, the biodegradable polymers include 2-4 weight parts of lignin powder, 3-5 weight parts of polycaprolactone, 2-3 weight parts of poly(acrylic acid) salt, and 1-4 weight parts of starch-acrylic acid graft copolymer.

The natural calcium carbonate and the activated charcoals can provide porous property for absorbing trace amounts of moisture and odor. In accordance with one or more embodiments of the present disclosure, the natural calcium carbonate is derived from shell, such as oyster shell, scallops shell, etc. In one embodiment, 5-6 weight parts of natural calcium carbonate is added. In accordance with one or more embodiments of the present disclosure, the activated charcoal is a bamboo charcoal, a bincho charcoal, a white charcoal, a wood charcoal, a coconut charcoal or mixed thereof. In one embodiment, 1-2 weight parts of activated charcoal are added.

The ratio of each foregoing component in the biodegradable desiccant grains can be adjusted to vary the moisture absorption capacity of the biodegradable desiccant grains. According to an example of the present disclosure, the biodegradable desiccant grains include 80-85 weight parts of the polylactide, 4 weight parts of the lignin powder, 1 weight parts of the bamboo is charcoal, 2 weight parts of the starch-acrylic acid graft copolymer, 6 weight parts of the shell powder, 2 weight parts of poly(acrylic acid) sodium salt, 3-5 of the polycaprolactone, and 2 weight parts of the polysaccharide containing uronic acid extracted from Spirulina. The moisture absorption capacity of the foregoing biodegradable desiccant grains is 40 wt %.

In addition, the foregoing biodegradable desiccant grains can be heated and dried after the moisture absorption capacity of the biodegradable desiccant grains is saturated. Therefore, the biodegradable desiccant grains can be reused.

The biodegradable desiccant grains above can be made by the following steps. A first mixture is blended with a second mixture to form a uniform mixture. In the uniform mixture, the materials of the second mixture with water absorbing and porous properties are carried by the first mixture. The uniform mixture is than granulated to form the biodegradable desiccant grains.

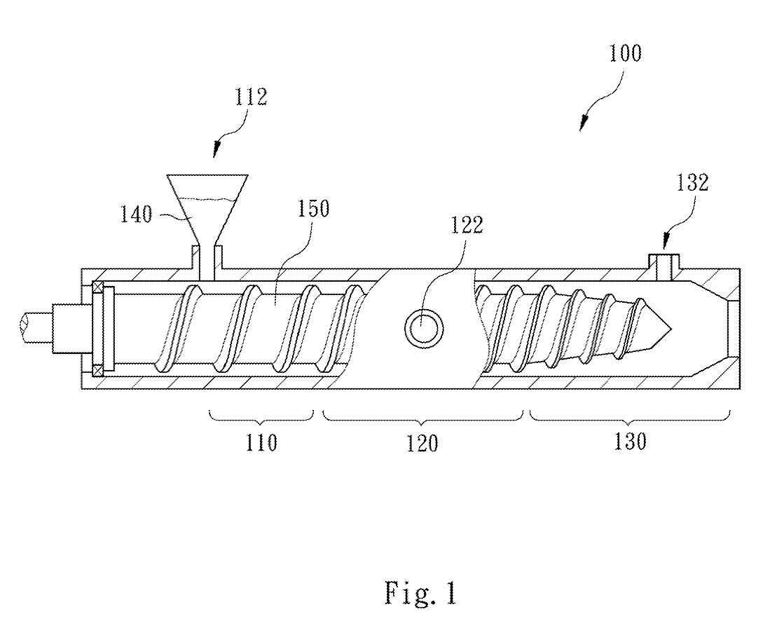

FIG. 1 is an operational and schematic view of a device for preparing biodegradable desiccant grains in accordance with an embodiment of the present disclosure. A mix mill 100 includes a chamber can be divided to a first mixing section 110, a second mixing section 120, and terminal section 130. A screw 150 set on center of the chamber and elongated from the first mixing section 110 to the terminal section 130. The mix mill 100 further includes a first entrance 112 set on the first mixing section 110, a second entrance 122 set on the first mixing section 120 and an exhausting device 132 set on the terminal section 130.

According to an embodiment, the polylactide matrix is blended with the lignin powder, the bamboo charcoal, the starch-acrylic acid graft copolymer, and the shell powder to forming a first mixture 140 as a carrier matrix of the biodegradable desiccant grains. The first mixture 140 is introduced into the mixing mill 100 from the first entrance 112, and heated and blended to form a hot molten first mixture 140 at 185-195° C. The hot molten first mixture 140 than be pushed and passing through the first mixing section 110.

A second mixture, includes the poly(acrylic acid) salt, polycaprolactone and the uronic acid-containing polysaccharide, is prepared and added separately to avoid the hydrophilic group between these components are covered with the hot molten polylactide. The second mixture is added into the mixing mill 100 from the second entrance 122 and blended with the moving hot molten first mixture 140 to from a uniform mixture.

For the sake of convenient use, the uniform mixture is granulated to form the biodegradable desiccant grains. When the uniform mixture is pushed to the terminal section 130, the uniform mixture is cooled and granulated by a cold air treatment without water. The humidity of the air is removed by the exhausting device 132 at the same time.

Since the polylactide has well moisture permeability and well air permeability. Therefore, although the water absorbent particles are dispersed in and surrounded by the polylactide matrix, the moisture still can penetrate the polylactide matrix and be absorbed by the water absorbent particles. Accordingly, the biodegradable desiccant grains can exhibit the same moisture absorption capacity as the conventional desiccant. Furthermore, the biodegradable desiccant grains can be fully biodegraded into water and CO₂ in the natural environment is more environment friendly than the conventional desiccant.

What is claimed is:

1. Biodegradable desiccant grains, comprising:
80-85 weight parts of a polylactide matrix; and
20-30 weight parts of a water absorbent particles dispersed in the matrix, wherein the water absorbent particles comprises a polysaccharide, biodegradable polymers, natural calcium carbonate, and an activated charcoal.

2. The biodegradable desiccant grains of claim 1, wherein the polysaccharide is a polysaccharide containing uronic acid extracted from Cyanobacteria.

3. The biodegradable desiccant grains of claim 1, wherein the biodegradable polymers comprise polycaprolactone, a starch-acrylic acid graft copolymer, a poly(acrylic acid) salt, and lignin.

4. The biodegradable desiccant grains of claim 3, wherein the poly(acrylic acid) salt is selected from a group consisting of poly(acrylic acid) sodium salt, poly(acrylic acid) potassium salt, and poly(acrylic acid) ammonium salt.

5. The biodegradable desiccant grains of claim 1, wherein the natural calcium carbonate is derived from shell.

6. The biodegradable desiccant grains of claim 1, wherein the activated charcoal is selected from a group consisting of a bamboo charcoal, a bincho charcoal, a white charcoal, a wood charcoal, a coconut charcoal and any combinations thereof.

7. The biodegradable desiccant grains of claim 1, wherein the water absorbent particles dispersed in the matrix comprising:
2-4 weight parts of uronic acid-containing polysaccharide extracted from Cyanobacteria
9-15 weight parts of biodegradable polymers, comprising 3-5 weight parts of polycaprolactone, 2-3 weight parts of poly(acrylic acid) sodium salt, 1-4 weight parts of starch-acrylic acid graft copolymer, and 2-4 weight parts of lignin;
5-6 weight parts of natural calcium carbonate; and
1-2 weight parts of activated charcoal.

8. A method for making biodegradable desiccant grains, the method comprising:
forming a first mixture as a carrier matrix of the biodegradable desiccant grains, wherein the first mixture comprises polylactide matrix, lignin, activated charcoal, starch-acrylic acid graft copolymer, and natural calcium carbonate;
blending the first mixture with a second mixture to form a uniform mixture, wherein the second mixture comprises a poly(acrylic acid) salt, polycaprolactone and an uronic acid-containing polysaccharide extracted from Cyanobacteria; and
granulating the uniform mixture to form the biodegradable desiccant grains.

9. The method of claim 8, comprising steps of:
introducing the first mixture into a mixing mill from a first entrance;
heating and blending the first mixture to form a hot molten first mixture;
introducing the second mixture into the mixing mill from a second entrance;
blending the second mixture with the hot molten mixture to form a uniform mixture; and
granulating the uniform mixture to form the biodegradable desiccant grains.

10. The method of claim 8, further comprising an exhausting operation to remove the humidity from the uniform mixture.

11. The method of claim 8; wherein the hot molten first mixture is formed at 185-195° C.

12. The method of claim 9, wherein the temperature of uniform mixture is decreased to 140-160° C. at a terminal section of the mixing mill to granulate the uniform mixture to biodegradable desiccant grains.
